(19) United States
(12) Patent Application Publication
(10) Pub. No.: US 2026/0056642 A1
(43) Pub. Date: Feb. 26, 2026

(54) THREE-DIMENSIONAL INTERACTION SYSTEM

(71) Applicant: Snap Inc., Santa Monica, CA (US)

(72) Inventors: Andrew James McPhee, Culver City, CA (US); Trevor Stephenson, Camarillo, CA (US); Pedram Javidpour, Santa Monica, CA (US); Ebony James Charlton, London (GB)

(21) Appl. No.: 19/338,633

(22) Filed: Sep. 24, 2025

Related U.S. Application Data
(63) Continuation of application No. 18/326,681, filed on May 31, 2023, now Pat. No. 12,443,325.
Application No. 18/326,681 is a continuation of application No. 15/804,550, filed on Nov. 6, 2017, now abandoned.
(60) Provisional application No. 62/449,451, filed on Jan. 23, 2017.
(60) Provisional application No. 62/473,933, filed on Mar. 20, 2017.

(51) Int. Cl. G06F 3/04815; G06F 3/01; G06F 3/0346; G06F 3/04845; G06F 3/0488; G06F 3/04883; G06T 19/00; G06T 19/20

(52) U.S. Cl. CPC G06F 3/04815; G06F 3/011; G06F 3/017; G06F 3/0346; G06F 3/04845; G06F 3/0488; G06F 3/04883; G06T 19/006; G06T 19/20; G06T 2219/2021; G06T 2219/2024

(57) ABSTRACT

Among other things, embodiments of the present disclosure improve the functionality of computer imaging software and systems by facilitating the manipulation of virtual content displayed in conjunction with images of real-world objects and environments. Embodiments of the present disclosure allow virtual objects to be moved relative to a real-world environment and manipulated in other ways.

### PRIORITY

This application is a continuation of U.S. patent application Ser. No. 18/326,681, filed May 31, 2023, which is a continuation of U.S. patent application Ser. No. 15/804,550, filed Nov. 6, 2017, which application claims the benefit of priority of U.S. Provisional Patent Application Ser. No. 62/449,451, filed on Jan. 23, 2017; and U.S. Provisional Patent Application Ser. No. 62/473,933, filed on Mar. 20, 2017, which are hereby incorporated by reference herein in their entirety.

### BACKGROUND

Augmented reality (AR) refers to supplementing the view of real-world objects and environments with computer-generated graphics content. Embodiments of the present disclosure address, among other things, the manipulation of virtual 3D objects in an AR environment.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram showing an example messaging system for exchanging data (e.g., messages and associated content) over a network.

FIG. 2 is block diagram illustrating further details regarding a messaging system, according to exemplary embodiments.

FIG. 3 is a schematic diagram illustrating data which may be stored in the database of the messaging server system, according to various exemplary embodiments.

FIG. 4 is a flow diagram of an exemplary process according to various aspects of the disclosure.

FIGS. 5A-5V are screenshots and diagrams illustrating various aspects of the systems and methods of the present disclosure.

FIG. 6 is a block diagram illustrating a representative software architecture, which may be used in conjunction with various hardware architectures herein described.

FIG. 7 is a block diagram illustrating components of a machine, according to some exemplary embodiments, able to read instructions from a machine-readable medium (e.g., a machine-readable storage medium) and perform any one or more of the methodologies discussed herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Among other things, embodiments of the present disclosure improve the functionality of computer imaging software and systems by facilitating the manipulation of virtual content displayed in conjunction with images of real-world objects and environments. Embodiments of the present disclosure allow virtual objects to be moved relative to a real-world environment and manipulated in other ways.

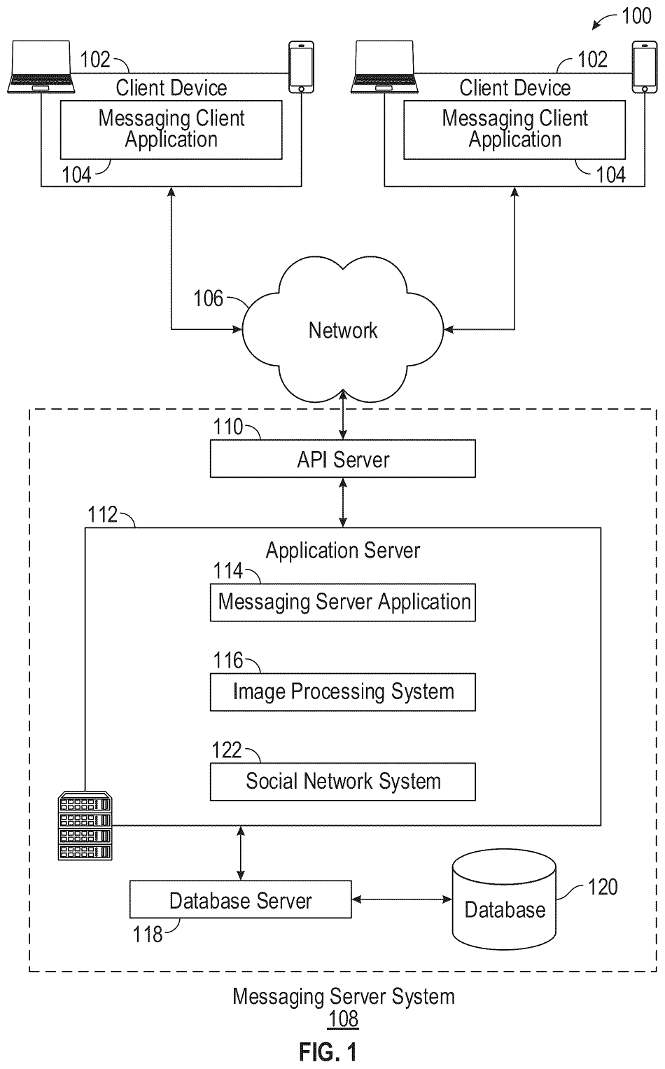

FIG. 1 is a block diagram showing an example of a messaging system 100 for exchanging data (e.g., messages and associated content) over a network. The messaging system 100 includes multiple client devices 102, each of which hosts a number of applications including a messaging client application 104. Each messaging client application 104 is communicatively coupled to other instances of the messaging client application 104 and a messaging server system 108 via a network 106 (e.g., the Internet). As used herein, the term “client device” may refer to any machine that interfaces to a communications network (such as network 106) to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

In the example shown in FIG. 1, each messaging client application 104 is able to communicate and exchange data with another messaging client application 104 and with the messaging server system 108 via the network 106. The data exchanged between messaging client applications 104, and between a messaging client application 104 and the messaging server system 108, includes functions (e.g., commands to invoke functions) as well as payload data (e.g., text, audio, video or other multimedia data).

The network 106 may include, or operate in conjunction with, an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The messaging server system 108 provides server-side functionality via the network 106 to a particular messaging client application 104. While certain functions of the messaging system 100 are described herein as being performed by either a messaging client application 104 or by the messaging server system 108, it will be appreciated that the location of certain functionality either within the messaging client application 104 or the messaging server system 108 is a design choice. For example, it may be technically preferable to initially deploy certain technology and functionality within the messaging server system 108, but to later migrate this technology and functionality to the messaging client application 104 where a client device 102 has a sufficient processing capacity.

The messaging server system 108 supports various services and operations that are provided to the messaging client application 104. Such operations include transmitting data to, receiving data from, and processing data generated by the messaging client application 104. This data may include, message content, client device information, geolocation information, media annotation and overlays, message content persistence conditions, social network information, and live event information, as examples. Data exchanges within the messaging system 100 are invoked and controlled through functions available via user interfaces (UIs) of the messaging client application 104.

Turning now specifically to the messaging server system 108, an Application Program Interface (API) server 110 is coupled to, and provides a programmatic interface to, an application server 112. The application server 112 is communicatively coupled to a database server 118, which facilitates access to a database 120 in which is stored data associated with messages processed by the application server 112.

Dealing specifically with the Application Program Interface (API) server 110, this server receives and transmits message data (e.g., commands and message payloads) between the client device 102 and the application server 112. Specifically, the Application Program Interface (API) server 110 provides a set of interfaces (e.g., routines and protocols) that can be called or queried by the messaging client application 104 in order to invoke functionality of the application server 112. The Application Program Interface (API) server 110 exposes various functions supported by the application server 112, including account registration, login functionality, the sending of messages, via the application server 112, from a particular messaging client application 104 to another messaging client application 104, the sending of electronic media files (e.g., electronic images or video) from a messaging client application 104 to the messaging server application 114, and for possible access by another messaging client application 104, the setting of a collection of media data (e.g., story), the retrieval of a list of friends of a user of a client device 102, the retrieval of such collections, the retrieval of messages and content, the adding and deletion of friends to a social graph, the location of friends within a social graph, opening and application event (e.g., relating to the messaging client application 104).

The application server 112 hosts a number of applications and subsystems, including a messaging server application 114, an image processing system 116 and a social network system 122. The messaging server application 114 implements a number of message processing technologies and functions, particularly related to the aggregation and other processing of content (e.g., textual and multimedia content including images and video clips) included in messages received from multiple instances of the messaging client application 104. As will be described in further detail, the text and media content from multiple sources may be aggregated into collections of content (e.g., called stories or galleries). These collections are then made available, by the messaging server application 114, to the messaging client application 104. Other processor and memory intensive processing of data may also be performed server-side by the messaging server application 114, in view of the hardware requirements for such processing.

The application server 112 also includes an image processing system 116 that is dedicated to performing various image processing operations, typically with respect to electronic images or video received within the payload of a message at the messaging server application 114.

The social network system 122 supports various social networking functions services, and makes these functions and services available to the messaging server application 114. To this end, the social network system 122 maintains and accesses an entity graph 304 within the database 120. Examples of functions and services supported by the social network system 122 include the identification of other users of the messaging system 100 with which a particular user has relationships or is “following”, and also the identification of other entities and interests of a particular user.

The application server 112 is communicatively coupled to a database server 118, which facilitates access to a database 120 in which is stored data associated with messages processed by the messaging server application 114.

Some embodiments may include one or more wearable devices, such as a pendant with an integrated camera that is integrated with, in communication with, or coupled to, a client device 102. Any desired wearable device may be used in conjunction with the embodiments of the present disclosure, such as a watch, eyeglasses, goggles, a headset, a wristband, earbuds, clothing (such as a hat or jacket with integrated electronics), a clip-on electronic device, or any other wearable devices.

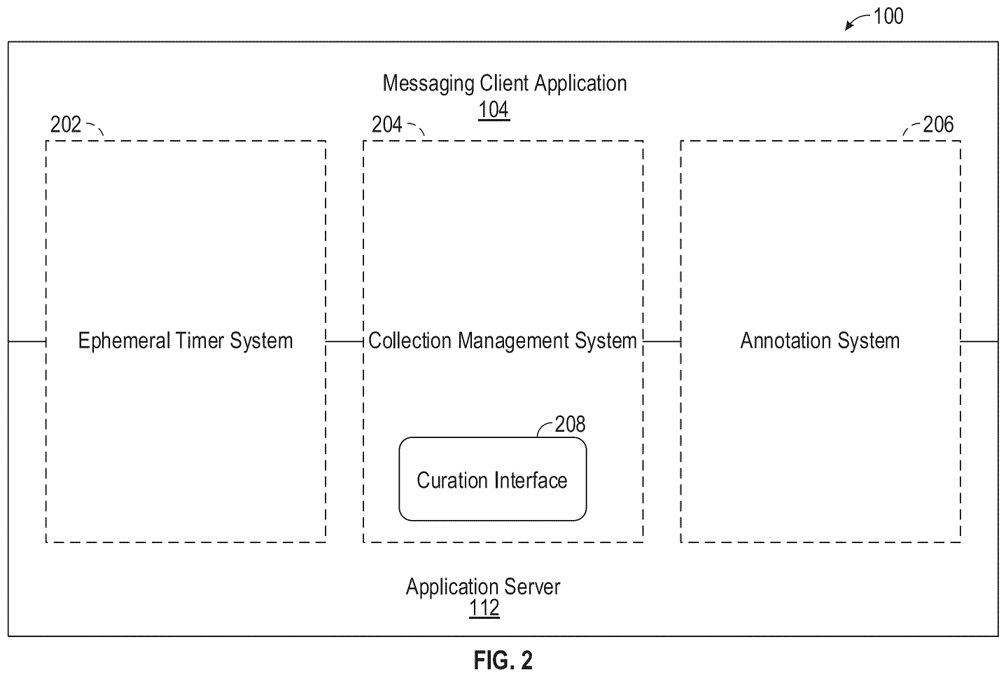

FIG. 2 is block diagram illustrating further details regarding the messaging system 100, according to exemplary embodiments. Specifically, the messaging system 100 is shown to comprise the messaging client application 104 and the application server 112, which in turn embody a number of some subsystems, namely an ephemeral timer system 202, a collection management system 204 and an annotation system 206.

The ephemeral timer system 202 is responsible for enforcing the temporary access to content permitted by the messaging client application 104 and the messaging server application 114. To this end, the ephemeral timer system 202 incorporates a number of timers that, based on duration and display parameters associated with a message, or collection of messages (e.g., a SNAPCHAT® story), selectively display and enable access to messages and associated content via the messaging client application 104.

The collection management system 204 is responsible for managing collections of media (e.g., collections of text, image, video and audio data). In some examples, a collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client application 104.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain embodiments, compensation may be paid to a user for inclusion of user generated content into a collection. In such cases, the curation interface 208 operates to automatically make payments to such users for the use of their content.

The annotation system 206 provides various functions that enable a user to annotate or otherwise modify or edit media content associated with a message. For example, the annotation system 206 provides functions related to the generation and publishing of media overlays for messages processed by the messaging system 100. The annotation system 206 operatively supplies a media overlay (e.g., a SNAPCHAT® filter) to the messaging client application 104 based on a geolocation of the client device 102. In another example, the annotation system 206 operatively supplies a media overlay to the messaging client application 104 based on other information, such as, social network information of the user of the client device 102. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., an image or video) at the client device 102. For example, the media overlay including text that can be overlaid on top of a photograph/electronic image generated by the client device 102. In another example, the media overlay includes an identification of a location overlay (e.g., Venice beach), a name of a live event, or a name of a merchant overlay (e.g., Beach Coffee House). In another example, the annotation system 206 uses the geolocation of the client device 102 to identify a media overlay that includes the name of a merchant at the geolocation of the client device 102. The media overlay may include other indicia associated with the merchant. The media overlays may be stored in the database 120 and accessed through the database server 118.

In some exemplary embodiments, as discussed in more detail below, embodiments of the present disclosure may generate, display, distribute, and apply media overlays to media content items. For example, embodiments may utilize media content items generated by a client device 102 (e.g., an image or video captured using a digital camera coupled to the client device 102) to generate media overlays that can be applied to other media content items.

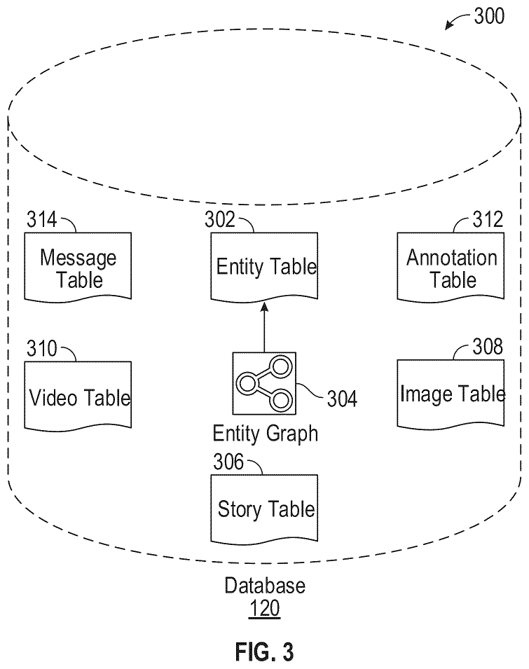

FIG. 3 is a schematic diagram 300 illustrating data 300 that is stored in the database 120 of the messaging server system 108, according to certain exemplary embodiments. While the content of the database 120 is shown to comprise a number of tables, the data could be stored in other types of data structures (e.g., as an object-oriented database).

The database 120 includes message data stored within a message table 314. The entity table 302 stores entity data, including an entity graph 304. Entities for which records are maintained within the entity table 302 may include individuals, corporate entities, organizations, objects, places, events etc. Regardless of type, any entity regarding which the messaging server system 108 stores data may be a recognized entity. Each entity is provided with a unique identifier, as well as an entity type identifier (not shown).

The entity graph 304 furthermore stores information regarding relationships and associations between entities. Such relationships may be social, professional (e.g., work at a common corporation or organization) interested-based or activity-based, merely for example.

The database 120 also stores annotation data, in the example form of filters, in an annotation table 312. Filters for which data is stored within the annotation table 312 are associated with and applied to videos (for which data is stored in a video table 310) or images (for which data is stored in an image table 308). Filters, in one example, are overlays that are displayed as overlaid on an image or video during presentation to a recipient user. Filters may be of varies types, including a user-selected filters from a gallery of filters presented to a sending user by the messaging client application 104 when the sending user is composing a message.

Other types of filters include geolocation filters (also known as Geofilters) which may be presented to a sending user based on geographic location. For example, geolocation filters specific to a neighborhood or special location may be presented within a user interface by the messaging client application 104, based on geolocation information determined by a GPS unit of the client device 102. Another type of filter is a data filter, which may be selectively presented to a sending user by the messaging client application 104, based on other inputs or information gathered by the client device 102 during the message creation process. Example of data filters include current temperature at a specific location, a current speed at which a sending user is traveling, battery life for a client device 102 or the current time. Other annotation data that may be stored within the image table 308 is so-called “Lens” data. A “Lens” may be a real-time special effect and sound that may be added to an image or a video.

As mentioned above, the video table 310 stores video data which, in one embodiment, is associated with messages for which records are maintained within the message table 314. Similarly, the image table 308 stores image data associated with messages for which message data is stored in the entity table 302. The entity table 302 may associate various annotations from the annotation table 312 with various images and videos stored in the image table 308 and the video table 310.

A story table 306 stores data regarding collections of messages and associated image, video or audio data, which are compiled into a collection (e.g., a SNAPCHAT® story or a gallery). The creation of a particular collection may be initiated by a particular user (e.g., each user for which a record is maintained in the entity table 302). A user may create a “personal story” in the form of a collection of content that has been created and sent/broadcast by that user. To this end, the user interface of the messaging client application 104 may include an icon that is user selectable to enable a sending user to add specific content to his or her personal story.

A collection may also constitute a “live story,” which is a collection of content from multiple users that is created manually, automatically or using a combination of manual and automatic techniques. For example, a “live story” may constitute a curated stream of user-submitted content from varies locations and events. Users, whose client devices have location services enabled and are at a common location event at a particular time may, for example, be presented with an option, via a user interface of the messaging client application 104, to contribute content to a particular live story. The live story may be identified to the user by the messaging client application 104, based on his or her location. The end result is a “live story” told from a community perspective.

A further type of content collection is known as a “location story,” which enables a user whose client device 102 is located within a specific geographic location (e.g., on a college or university campus) to contribute to a particular collection. In some embodiments, a contribution to a location story may require a second degree of authentication to verify that the end user belongs to a specific organization or other entity (e.g., is a student on the university campus).

Embodiments of the present disclosure may generate and present customized images for use within electronic messages/communications such as short message service (SMS) or multimedia message service (MMS) texts and emails. The customized images may also be utilized in conjunction with the SNAPCHAT stories, SNAPCHAT filters, and ephemeral messaging functionality discussed herein.

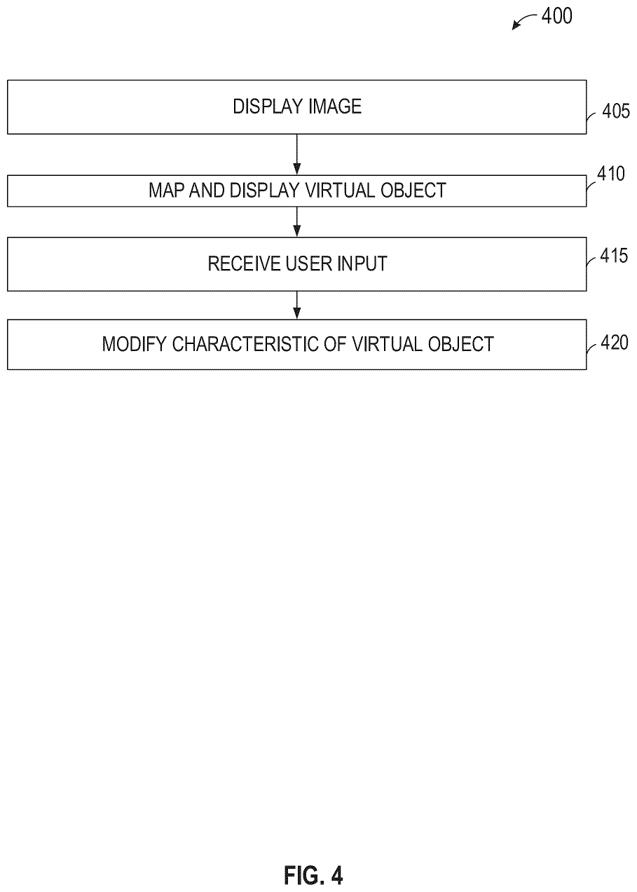

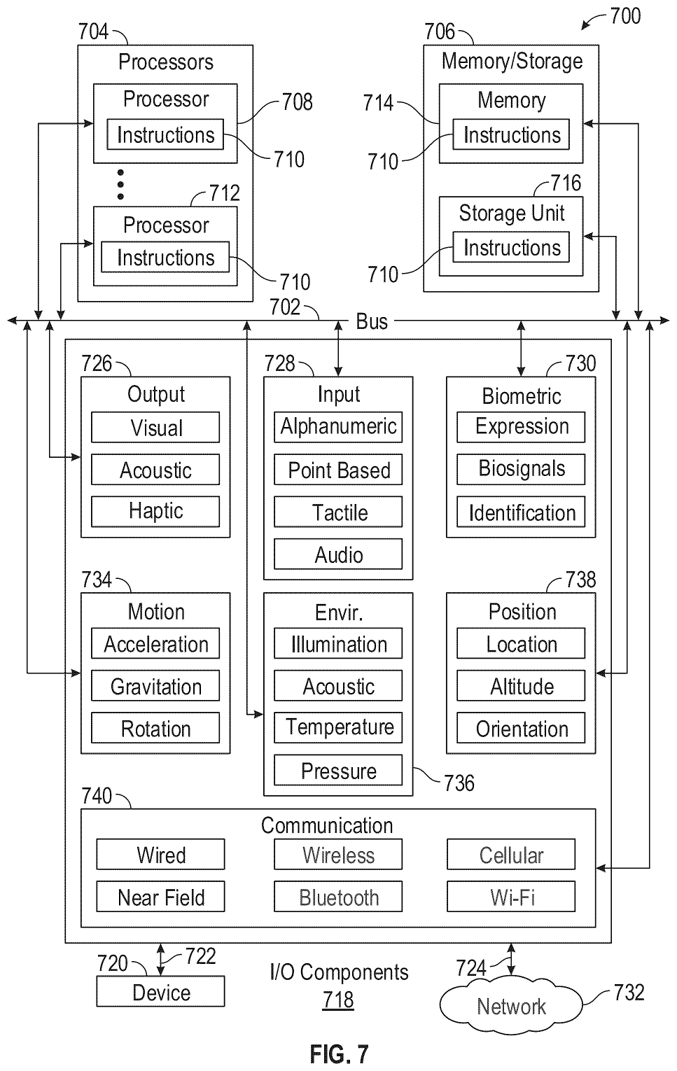

FIG. 4 depicts an exemplary process according to various aspects of the present disclosure. In this example, method 400 includes displaying an image of a real-world scene (e.g., captured via the camera of a mobile computing device) on the display of the computing device (405), mapping and displaying a virtual object in the real-world scene (410), receiving input from a user (415), and modifying a characteristic of the virtual object (420). The steps of method 400 may be performed in whole or in part, may be performed in conjunction each other as well as with some or all of the steps in other methods, and may be performed by any number of different systems, such as the systems described in FIGS. 1 and 7.

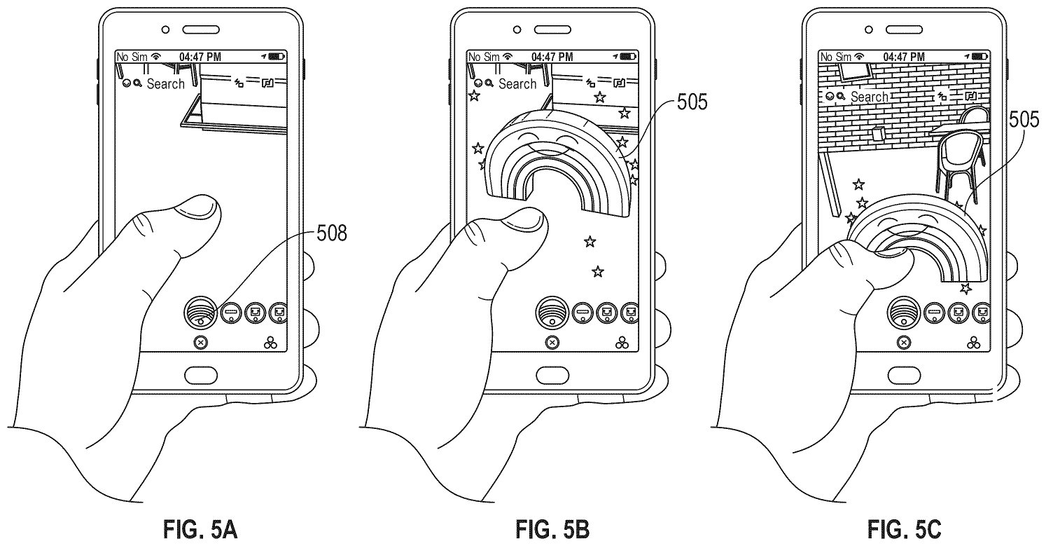

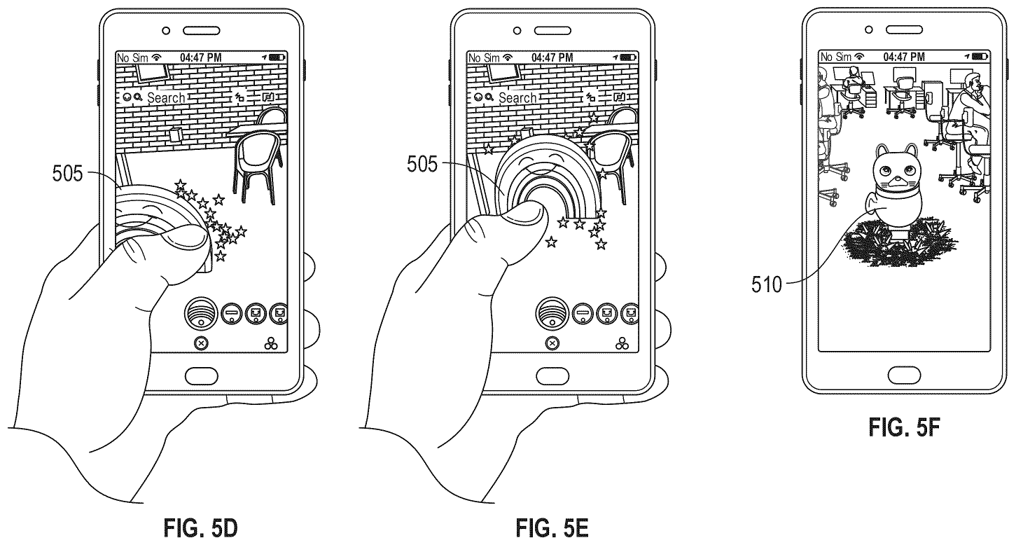

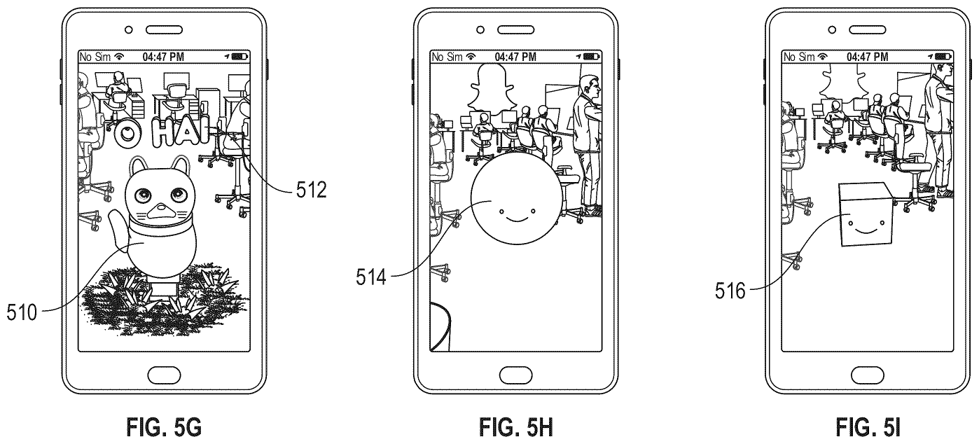

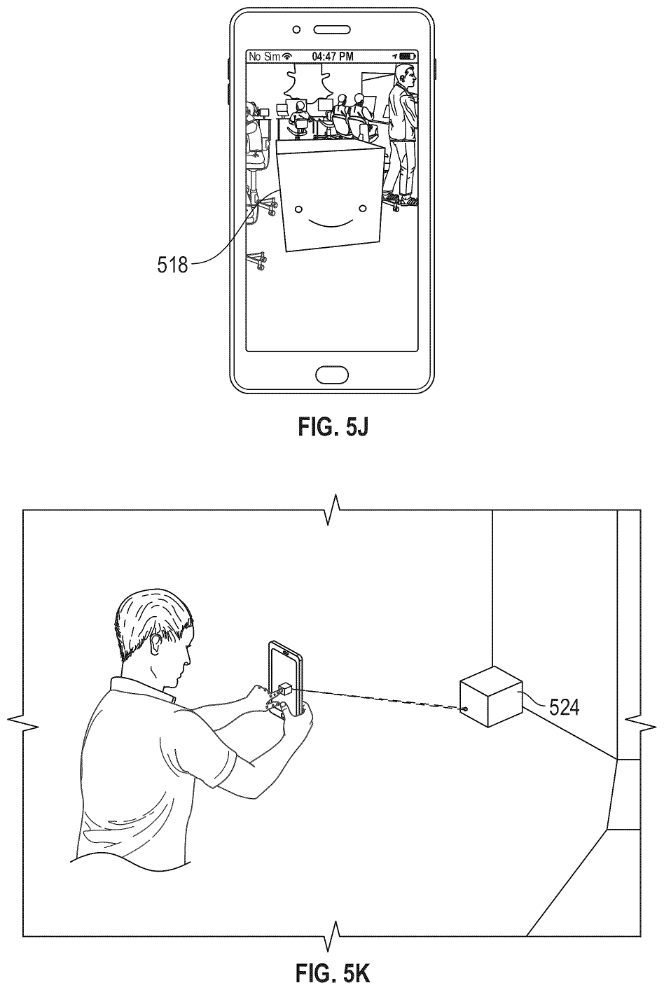

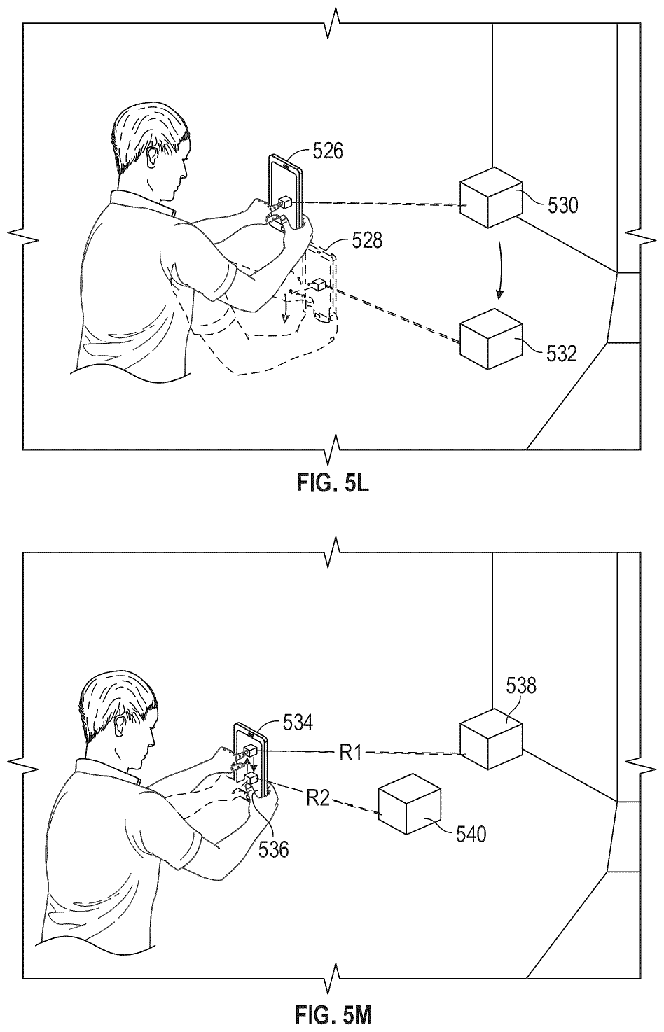

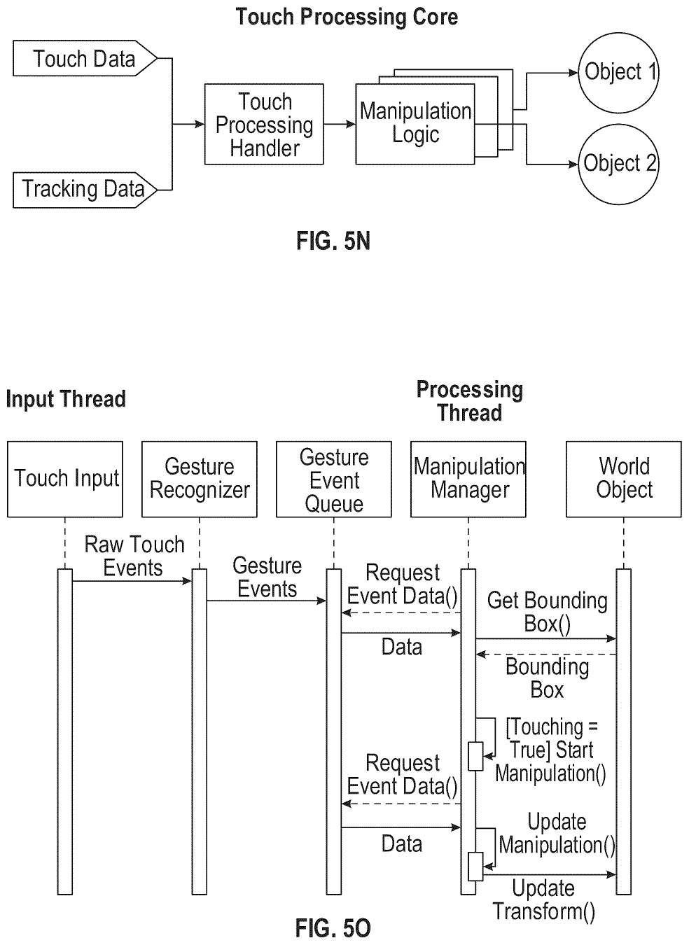

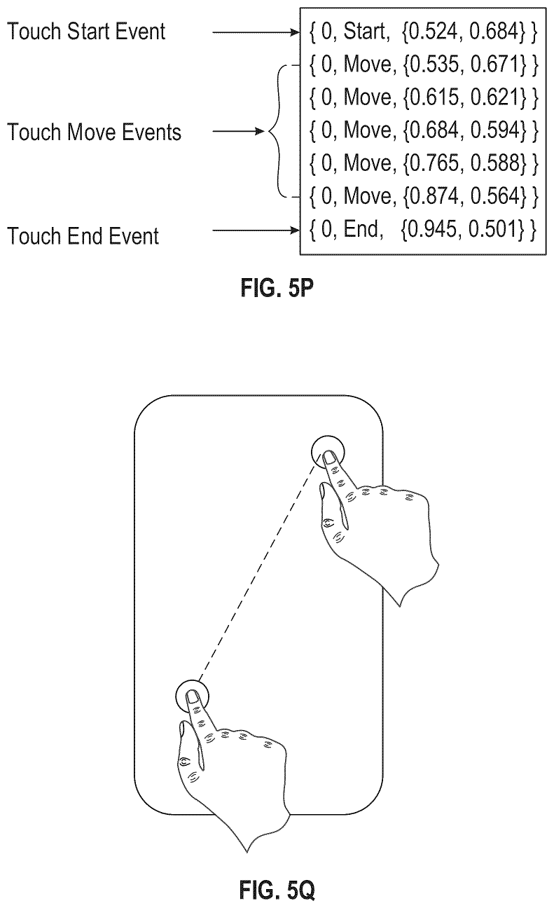

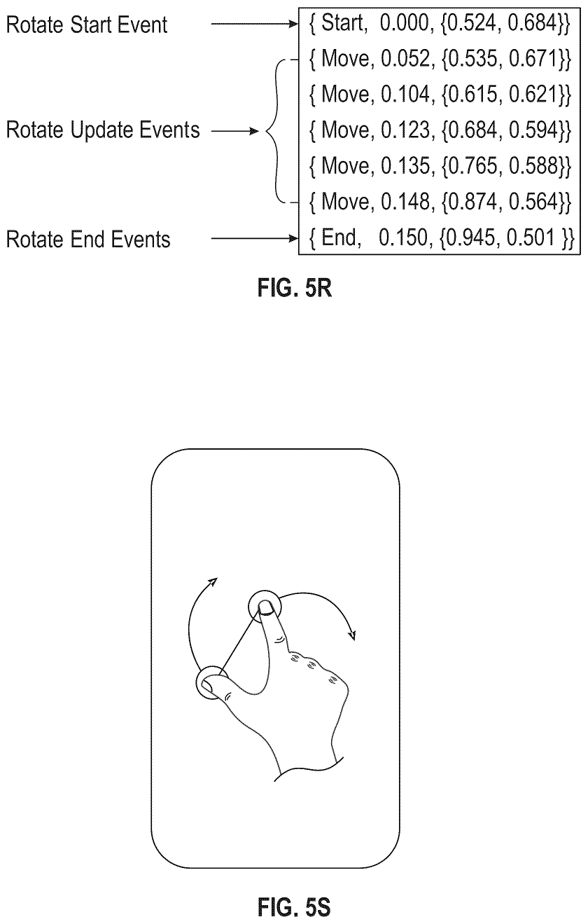

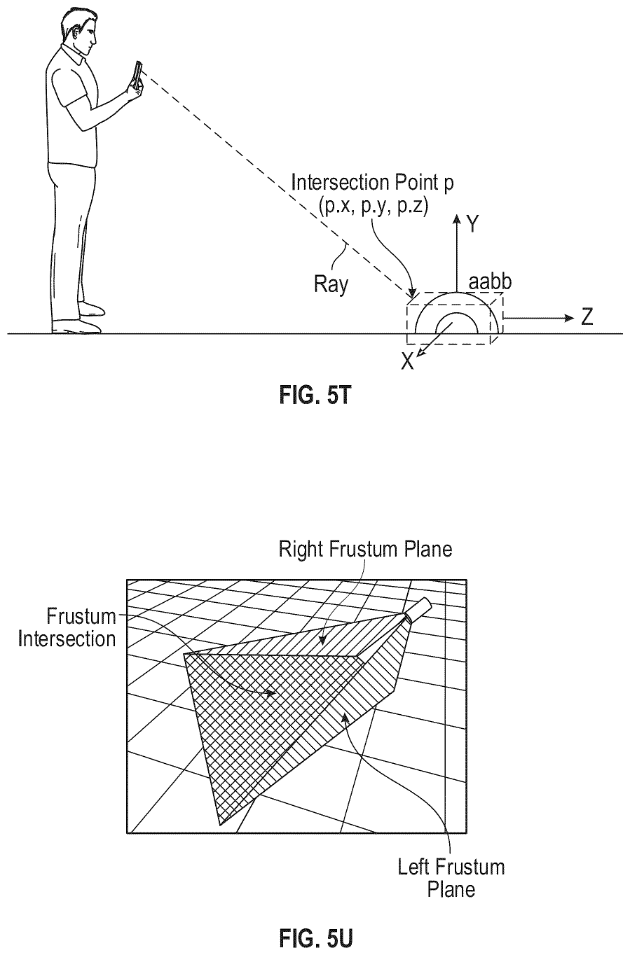

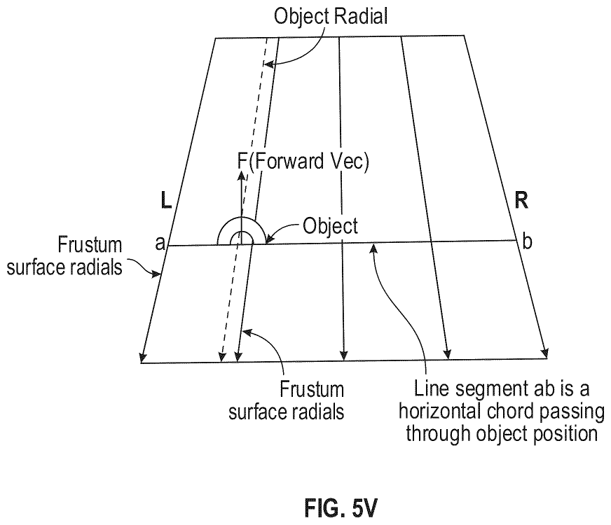

In method 400, the system displays (405) a two-dimensional (2D) image of a three-dimensional (3D) real-world scene on the display screen of a computing device. In some embodiments, the image may be a still image or previously-recorded video (e.g., previously captured by the camera of the computing device). In other embodiments, the image may be part of a live video or stream captured through the camera and displayed on the display screen. In this context, an image of a “real-world scene” refers to an image of tangible, physical objects, while a “virtual object” refers to a computer-generated object. In FIGS. 5A-5C, for example, the image captured via the camera of the user's mobile device displays various physical objects of a real-world scene, such as the floor, chairs, and other furniture, while FIGS. 5B and 5C further include a virtual object 505 (a smiling rainbow) that is mapped to the real-world scene and displayed in conjunction with the real-world objects (as described in more detail below).

The system may map a virtual object to a three-dimensional real-world scene and display (410) the virtual object within the two-dimensional image displayed on the display screen of the computing device. Any number and type of different virtual objects may be mapped and displayed within the image, including text, animations, avatars of users, and other objects. In the screenshots shown in FIGS. 5B-5E, for instance, the image includes a virtual object 505 comprising a 3D smiling rainbow mapped to the real-world scenes captured by the camera of the mobile computing device. In FIG. 5F, the virtual object 510 is a cat.

Embodiments of the present disclosure allow a user to place virtual objects in any selected position within the image, as well as to interact with the objects. In FIG. 5A, for example, the user selects a virtual object from a gallery of objects displayed at the bottom of the screen, pressing selection 508 for a rainbow virtual object and then tapping the screen with the user's thumb. In FIG. 5B, in response to the user's input, the system maps the virtual object 505 to the real-world scene, identifying the floor of the real-world scene as the position corresponding to the user's selection, and thus mapping the virtual object 505 to the selected position on the floor.

The system may receive input from a user (415) and modify a characteristic of the virtual object in response to the input (420) and/or in response to other conditions and events. Characteristics of the virtual object that may be modified include, for example, the position of the virtual object in the real-world scene. Virtual objects and other content in an image can be manipulated in a variety of different ways, including adding new virtual objects to an image, removing virtual objects from an image, repositioning virtual content, and modifying the virtual content (e.g., changing its size, scale, direction/orientation/rotation, color, shape, etc.). A variety of virtual content may be displayed, including text, video, and images. Additionally, the system may modify non-visual characteristics of the virtual object, such as an internal state value of the virtual object. The visual characteristics of different portions of the virtual object may be modified differently from each other. In FIGS. 5H-5I, for example, the shape of a virtual object may be transformed between a sphere 514 and a cube 516 in response to various inputs or events. As shown in FIGS. 5I and 5J, the scale of a virtual object may be varied independently of its position within the real-world scene. Between FIG. 5I and FIG. 5J, the position of the virtual object remains constant, though the scale of virtual object 518 is increased from the scale of virtual object 516.

In FIGS. 5C-5E, the user selects the virtual object 505 by pressing the user's thumb on the touchscreen on the virtual object 505 (FIG. 5C). The user may hold his/her thumb on the touchscreen and drag the virtual object 505 to reposition it. For example, in FIG. 5D the user is swiping the user's thumb to the left, and the system moves the object with the user's swipe laterally to the left. In FIG. 5E, the user is swiping the user's thumb up, and the system repositions the virtual object 505 deeper within the real-world scene as a result. In other examples, the user may select the virtual object 505 by tapping on it, then moving the virtual object by tapping on another location on the touchscreen.

The system may identify the selection of a virtual object by a user by determining an intersection between a selection position on the user's display and the mapped position of the virtual object in real-world space. FIG. 5U illustrates an example where a user touches an area on the screen of the user's computing device where the virtual object is located. In response, the system raycasts (i.e., projects) the 2D touch position on the computing device screen to the virtual object's position in the 3D real world scene captured by the computing device's camera to determine whether they intersect. In this specific example, the system computes the offset from the object's origin on the display screen to the intersection point on the axis-aligned bounding-box (aabb). Additionally, the system computes the object orientation about the up-axis (y) relative to the camera.

In some embodiments, movement of the virtual object from a first position to a second position includes determining a frustum-relative orientation for the virtual object and maintaining the frustum-relative orientation for the virtual object between the first position and the second position. FIG. 5V illustrates an example of a frustum intersection with a ground plane producing a trapezoidal two-dimensional plane having a left frustum plane and a right frustum plane. In FIG. 5W, frustum surface radials are defined as radial lines running along the trapezoid, where “L” and “R” are the intersections between the left and right frustum planes with the surface, respectively. The inner radials are interpolated.

Movement of a user's computing device may be interpreted in conjunction with selection of a virtual object to modify a characteristic of the virtual object (such as the virtual object's position in real-world space). FIG. 5K illustrates an example of a user selecting a virtual object 524 on the screen of the user's mobile computing device. In this example, the position of the virtual object 524 is depicted at the position in real-world space to which it is mapped. In FIG. 5L, the user selects the virtual object on the screen and moves the user's computing device from a first position 526 to a second position 528, causing the virtual object to be re-mapped in three-dimensional real-world space from position 530 to position 532. The user physically walking around with the virtual object selected may also translate the virtual object from one position to another. Similarly, in FIG. 5M, the user slides his finger from a first position on the screen 534 downwards to a second position on the screen 536, adjusting the depth of the virtual object in the image from a first position 538 at radius R1 to a second position 540 at radius R2. In some embodiments, the system may identify a spatial limit in the three-dimensional real-world scene, such as the ground or a physical object (e.g., a table or wall) and restrict movement of the virtual object based on the spatial limit. In a particular example, the system may prevent a virtual object being moved below the ground plane or through a wall or other physical object.

The system may operate in conjunction with any of a variety of different user gestures and inputs. Additionally, while inputs from the user are described herein with reference to a user interacting with a touchscreen, embodiments of the present disclosure may receive inputs in a variety of other input formats, such as input received from a keyboard, mouse, voice instructions via a microphone, etc.

FIG. 5N is a diagram of an exemplary software architecture that may be used in conjunction with some embodiments for handling input from a user. In this example, touch data and tracking data is received by a touch processing handler. Manipulation logic units are applied in layers (e.g., translation, scaling, rotating, etc.). The manipulation layer outputs are accumulated and applied as object transformations (e.g., Object 1 and Object 2). In this example, each manipulation unit consumes a particular type of touch/gesture as input and produces an augment as output. Units can be combined to produce a unique control scheme. Examples of manipulation units include units for scale, rotation, swiveling, translation, height adjustment, and depth adjustment.

FIG. 5O is an example of a software process diagram that may be employed by embodiments of the present disclosure. In this example, touch data is interpreted by gesture recognizer in the input thread, and sent to a gesture event queue. The manipulation manager executes in the core thread, consuming the event buffer and translating the gesture data into three-dimensional transformations applied to real-world objects. In conjunction with the manipulation units illustrated in FIG. 5N, the system may interpret a variety of touchscreen gestures made by a user. For example, the system may implement a two-dimensional screen coordinate system with left and right movement along an “x” axis and up and down movement along a “y” axis. The system may likewise implement a three-dimensional coordinate system for the real-world scene, with, for example, the ground plane defined in an “xz” plane (width and depth) and height along a “y” axis. In this example, translation actions on a virtual object may include identifying the “x” and “y” components of a one-finger scroll gesture by the user and applying the gesture to a translation of the object in the “xz” plane of the real-world scene. In a particular example of virtual object translation, referring again to FIGS. 5C-5E, the user presses a single finger (the user's thumb) on the touch screen to select the virtual object 505 (FIG. 5C) and slides the user's thumb to the left to move the virtual object 505 to the left (FIG. 5D) and up to adjust the position of the virtual object 505 deeper in the image (FIG. 5E). In alternate embodiments, the system may interpret a single-finger movement on the touch screen to adjust the position of the virtual object in only the x and y planes (leaving depth unchanged) while interpreting a two-finger selection and movement of the virtual object by the user to adjust the depth of the virtual object (e.g., deeper or shallower in the real-world scene). The system may operate in conjunction with a variety of different inputs to manipulate the position of the virtual object within the real-world scene.

A virtual object may be mapped to a three-dimensional real-world scene in a variety of ways. In one example, the system generates a matrix containing image data from the camera of the user's mobile computing device and movement data received from the device's inertial measurement sensor. The movement of a computing device (such as a smartphone) may be tracked by the system to add, remove, and/or modify virtual content to the real-world scene. For example, the system may implement a virtual paintbrush utility whereby a user moves the user's mobile device in three-dimensional space, leaving a trail of virtual lines on the screen and allowing the user to generate a virtual painting displayed in conjunction with a real-world scene. The system may track the movement of the device in three-dimensions, (e.g., tracking forward and backward movements of the computing device to add depth to the painting), to give the virtual painting a three-dimensional appearance.

FIGS. 5P and 5Q illustrate one example of a matrix generated in response to a user pressing on the touchscreen at a first position (reflected in the matrix as “touchStartEvent”) and sliding the user's finger diagonally across the screen (reflected in the matrix as the “touchMoveEvents”) to a second position (reflected in the matrix as the “touchEndEvent”).

FIGS. 5S and 5T illustrate another example where the user performs a two-fingered rotation gesture on the screen to rotate a virtual object. In this example, the user presses on the screen at a first position (“rotateStartEvent”), and rotates the user's fingers clockwise (“rotateUpdateEvents”) to a second position (“rotateEndEvent”).

In conjunction with repositioning the virtual object 505 deeper or shallower within a real-world scene, the system may adjust the size of the virtual object to appropriately scale the object. In FIG. 5E, for example, the size of the virtual object is reduced as it is moved to the background of the scene, relative to its larger size in the foreground of the scene in FIG. 5C. Additionally, the system may display animations or other effects during and/or after input by a user. In FIGS. 5D and 5E, for example, trails of animated stars are displayed as the virtual object 505 is moved.

As noted above, the system may modify characteristics of virtual objects (420) in response to various events, including changes in the image, date, time, geolocation information, the context of events occurring within the image, and others. In some embodiments input to the system may be received from one or more sensors, and the system may modify characteristics of the virtual object in response. In one embodiment, a mobile computing device implementing the functionality of method 400 includes an inertial measurement sensor (such as an accelerometer) that detects movement of mobile computing device. In FIG. 5F, for example, a virtual object 510 (a cat) is displayed sitting on the floor of a real-world scene captured by the camera of the user's smartphone. In FIG. 5G, the user moves toward the virtual object's mapped position in the real-world scene. As the mobile device (carried by the user) gets closer to the virtual object 510, the system increases the size of object 510, just as a physical object would appear larger to a user as the user approached it. In response to the mobile device approaching within a predetermined distance of the virtual object's mapped position in the real-world scene, the system triggers a reaction in the virtual object 510, namely the cat waving it's paw to the user and displaying “O Hai” text above the cat's head. The system may detect other types of events as well, such as a collision or contact between a virtual object in an image and a physical element (such as the user's hand or other body part) and invoke behavior for the virtual object in response.

Embodiments of the present disclosure may measure a variety of different types of movement of the system, such as a change in elevation, rotation of the system about an axis, movement/repositioning of the system from one position to another, the speed of movement of the system, the change in speed of the system (e.g., acceleration or deceleration), etc. Embodiments of the present disclosure may also update the presentation of the virtual object within the image as the system moves relative to the virtual object's mapped position within the real-world. For example, a virtual object may be mapped to a fixed position on the ground in front of a user holding a mobile computing device, such as the rainbow 505 depicted in FIG. 5B. The user may move in a circle around the virtual object 505 (with the camera of the mobile device fixed on the virtual object 505), and the system updates the displayed perspective of the object to reflect the changing position of the user's mobile device relative to the virtual object. For example, the system displays the smiling face of the rainbow 505 as the user stands in front of the rainbow, but modifies the view of the rainbow to show its sides and rear as the user moves around the object 505.

The display of virtual objects may be performed for a limited, predetermined time period or based on event criteria. For example, in the case of the examples shown in FIGS. 5F-5G, the cat may be displayed within the image for a predetermined period of time unless the user interacts with the cat in some manner (e.g., within an hour), otherwise the cat may be depicted as walking away (e.g, leaving the image).

The system may display images containing virtual objects as part of, or in conjunction with, a variety of media content items. In this context, a “media content item” may include any type of electronic media in any format. For example, a media content item may include an image in JPG format, an image in PNG format, a video in FLV format, a video in AVI format, etc. In some exemplary embodiments, a media content item may include content that is captured using an image capture device or component (such as a digital camera) coupled to, or in communication with, a system performing the functionality of method 400. In the exemplary system 700 depicted in FIG. 7 may include a digital camera as one of input components 728. Additionally or alternatively, the media content item may be received from another system or device. In FIG. 1, for example, a client device 102 performing the functionality of method 400 may receive a media content item from another client device 102 or other system via network 106.

In some embodiments, the media content item generated or used by the system may be included in a media overlay such as a “sticker” (i.e., an image that can be overlaid onto other images), filter (discussed above), or another media overlay. Such overlays may include static (i.e., non-moving) features as well as dynamic (i.e., moving) features. Generation of media content items by embodiments of the present disclosure may include the generation of one or more data structure fields containing information regarding the content item. For example, the system may generate a name field in a data structure for the media overlay that includes a name for the media content item received from the content provider. Media content items may be shared in real-time or near-real time with other computing devices and systems.

Embodiments of the present disclosure may transmit and receive electronic communications containing media content items, media overlays, or other content any form of electronic communication, such as SMS texts, MMS texts, emails, and other communications. Media content items included in such communications may be provided as attachments, displayed inline in the message, within media overlays, or conveyed in any other suitable manner.

### Software Architecture

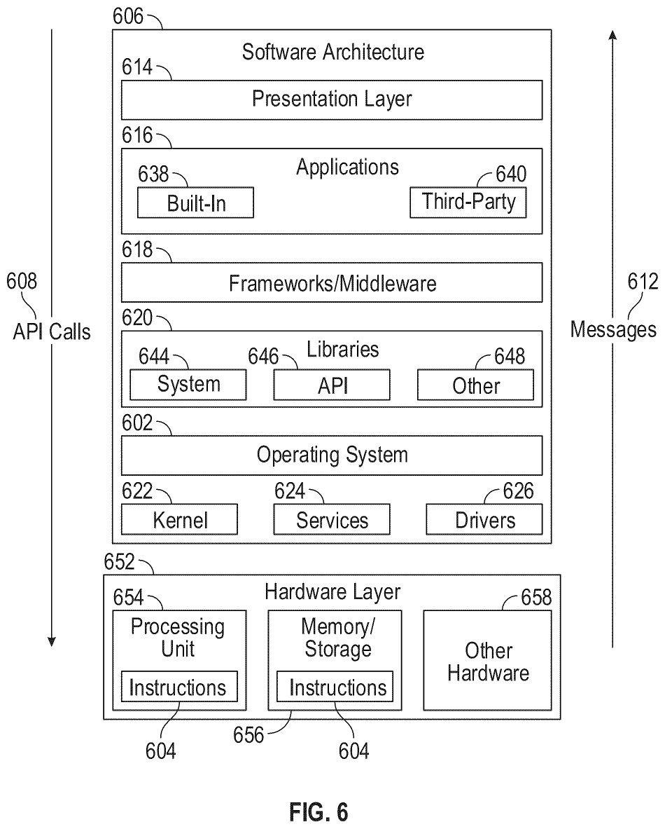

FIG. 6 is a block diagram illustrating an exemplary software architecture 606, which may be used in conjunction with various hardware architectures herein described. FIG. 6 is a non-limiting example of a software architecture and it will be appreciated that many other architectures may be implemented to facilitate the functionality described herein. The software architecture 606 may execute on hardware such as machine 700 of FIG. 7 that includes, among other things, processors 704, memory 714, and I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components and so forth described herein. The hardware layer 652 also includes memory or storage modules memory/storage 656, which also have executable instructions 604. The hardware layer 652 may also comprise other hardware 658.

As used herein, the term “component” may refer to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions.

Components may constitute either software components (e.g., code embodied on a machine-readable medium) or hardware components. A “hardware component” is a tangible unit capable of performing certain operations and may be configured or arranged in a certain physical manner. In various exemplary embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

A processor may be, or in include, any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access.

For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component”refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components.

Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some exemplary embodiments, the processors or processor-implemented components may be located in a single geographic location (e.g., within a home environment, an office environment, or a server farm). In other exemplary embodiments, the processors or processor-implemented components may be distributed across a number of geographic locations.

In the exemplary architecture of FIG. 6, the software architecture 606 may be conceptualized as a stack of layers where each layer provides particular functionality. For example, the software architecture 606 may include layers such as an operating system 602, libraries 620, applications 616 and a presentation layer 614. Operationally, the applications 616 or other components within the layers may invoke application programming interface (API) API calls 608 through the software stack and receive messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624 and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 or other components or layers. The libraries 620 provide functionality that allows other software components to perform tasks in an easier fashion than to interface directly with the underlying operating system 602 functionality (e.g., kernel 622, services 624 or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 or other software components/modules. For example, the frameworks/middleware 618 may provide various graphic user interface (GUI) functions, high-level resource management, high-level location services, and so forth. The frameworks/middleware 618 may provide a broad spectrum of other APIs that may be utilized by the applications 616 or other software components/modules, some of which may be specific to a particular operating system 602 or platform.

The applications 616 include built-in applications 638 or third-party applications 640. Examples of representative built-in applications 638 may include, but are not limited to, a contacts application, a browser application, a book reader application, a location application, a media application, a messaging application, or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624 or drivers 626), libraries 620, and frameworks/middleware 618 to create user interfaces to interact with users of the system. Alternatively, or additionally, in some systems interactions with a user may occur through a presentation layer, such as presentation layer 614. In these systems, the application/component “logic” can be separated from the aspects of the application/component that interact with a user.

FIG. 7 is a block diagram illustrating components (also referred to herein as “modules”) of a machine 700, according to some exemplary embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

As used herein, the term “machine-readable medium,” “computer-readable medium,” or the like may refer to any component, device or other tangible media able to store instructions and data temporarily or permanently. Examples of such media may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions. The term “machine-readable medium” may also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” may refer to a single storage apparatus or device, as well as “cloud-based” storage systems or storage networks that include multiple storage apparatus or devices. The term “machine-readable medium”excludes signals per se.

The I/O components 718 may include a wide variety of components to provide a user interface for receiving input, providing output, producing output, transmitting information, exchanging information, capturing measurements, and so on. The specific I/O components 718 that are included in the user interface of a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various exemplary embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like. The input components 728 may also include one or more image-capturing devices, such as a digital camera for generating digital images or video.

In further exemplary embodiments, the I/O components 718 may include biometric components 730, motion components 734, environmental environment components 736, or position components 738, as well as a wide array of other components. One or more of such components (or portions thereof) may collectively be referred to herein as a “sensor component” or “sensor” for collecting various data related to the machine 700, the environment of the machine 700, a user of the machine 700, or a combinations thereof.

For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, velocity sensor components (e.g., speedometer), rotation sensor components (e.g., gyroscope), and so forth. The environment components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 may include location sensor components (e.g., a Global Position system (GPS) receiver component), altitude sensor components (e.g., altimeters or barometers that detect air pressure from which altitude may be derived), orientation sensor components (e.g., magnetometers), and the like. For example, the location sensor component may provide location information associated with the system 700, such as the system's 700 GPS coordinates or information regarding a location the system 700 is at currently (e.g., the name of a restaurant or other business).

Communication may be implemented using a wide variety of technologies. The I/O components 718 may include communication components 740 operable to couple the machine 700 to a network 732 or devices 720 via coupling 722 and coupling 724 respectively. For example, the communication components 740 may include a network interface component or other suitable device to interface with the network 732. In further examples, communication components 740 may include wired communication components, wireless communication components, cellular communication components, Near Field Communication (NFC) components, Bluetooth® components (e.g., Bluetooth@ Low Energy), Wi-Fi® components, and other communication components to provide communication via other modalities. The devices 720 may be another machine or any of a wide variety of peripheral devices (e.g., a peripheral device coupled via a Universal Serial Bus (USB)).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as, location via Internet Protocol (IP) geo-location, location via Wi-Fi® signal triangulation, location via detecting a NFC beacon signal that may indicate a particular location, and so forth.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2016, SNAP, INC. 2016, All Rights Reserved.

What is claimed is:

1. A method, comprising:
displaying a two-dimensional image of a three-dimensional real-world scene on a display screen of a computing device;
mapping a virtual object to the three-dimensional real-world scene and displaying the virtual object within the two-dimensional image;
receiving input from a user to move the virtual object in the real-world scene; restricting, by the one or more processors, movement of the virtual object based on a spatial limit in the three-dimensional real-world scene; and
modifying a position of the virtual object in response to the input and the spatial limit.

2. The method of claim 1, wherein the spatial limit comprises a ground plane in the real-world scene.

3. The method of claim 1, wherein the spatial limit comprises a physical object in the real-world scene.

4. The method of claim 3, wherein restricting movement comprises preventing the virtual object from being moved below the ground plane.

5. The method of claim 1, wherein restricting movement comprises preventing the virtual object from being moved through a physical object.

6. The method of claim 1, wherein receiving input comprises detecting selection of the virtual object by determining an intersection between a selection position on the display screen and a mapped position of the virtual object in real-world space.

7. The method of claim 1, wherein movement of the virtual object includes determining a frustum-relative orientation for the virtual object and maintaining the frustum-relative orientation for the virtual object during movement.

8. A machine, comprising:
one or more processors; and
a memory storing instructions that, when executed by the one or more processors, cause the machine to perform operations comprising:
displaying a two-dimensional image of a three-dimensional real-world scene on a display screen of a computing device;
mapping a virtual object to the three-dimensional real-world scene and displaying the virtual object within the two-dimensional image;
receiving input from a user to move the virtual object in the real-world scene; restricting, by the one or more processors, movement of the virtual object based on a spatial limit in the three-dimensional real-world scene; and
modifying a position of the virtual object in response to the input and the spatial limit.

9. The machine of claim 8, wherein the spatial limit comprises a ground plane in the real-world scene.

10. The machine of claim 8, wherein the spatial limit comprises a physical object in the real-world scene.

11. The machine of claim 10, wherein restricting movement comprises prevening the virtual object from being moved below the ground plane.

12. The machine of claim 8, wherein restricting movement comprises prevening the virtual object from being moved through a physical object.

13. The machine of claim 8, wherein receiving input comprises detecting selection of the virtual object by determining an intersection between a selection position on the display screen and a mapped position of the virtual object in real-world space.

14. The machine of claim 8, wherein movement of the virtual object includes determining a frustum-relative orientation for the virtual object and maintaining the frustum-relative orientation for the virtual object during movement.

15. A machine-storage medium storing machine-executable instructions that, when executed by a machine, cause the machine to perform operations comprising:
displaying a two-dimensional image of a three-dimensional real-world scene on a display screen of a computing device;
mapping a virtual object to the three-dimensional real-world scene and displaying the virtual object within the two-dimensional image;
receiving input from a user to move the virtual object in the real-world scene; restricting, by the one or more processors, movement of the virtual object based on a spatial limit in the three-dimensional real-world scene; and
modifying a position of the virtual object in response to the input and the spatial limit.

16. The machine-storage medium of claim 15, wherein the spatial limit comprises a ground plane in the real-world scene.

17. The machine-storage medium of claim 15, wherein the spatial limit comprises a physical object in the real-world scene.

18. The machine-storage medium of claim 17, wherein restricting movement comprises prevening the virtual object from being moved below the ground plane.

19. The machine-storage medium of claim 15, wherein restricting movement comprises prevening the virtual object from being moved through a physical object.

20. The machine-storage medium of claim 15, wherein movement of the virtual object includes determining a frustum-relative orientation for the virtual object and maintaining the frustum-relative orientation for the virtual object during movement.
